(19) United States
(12) Patent Application Publication
(10) Pub. No.: US 2025/0095460 A1
(43) Pub. Date: Mar. 20, 2025

(54) LOCATOR FOR CABLE ROD

(71) Applicants: Ka Wo Yeung, Milton Keynes (GB); Wai Kit Lai, Birmingham (GB)

(72) Inventors: Ka Wo Yeung, Milton Keynes (GB); Wai Kit Lai, Birmingham (GB)

(21) Appl. No.: 18/885,327

(22) Filed: Sep. 13, 2024

(30) Foreign Application Priority Data
Sep. 15, 2023 (GB) GB2314095.7

(51) Int. Cl. G08B 7/06; H02G 1/08

(52) U.S. Cl. CPC G08B 7/06; H02G 1/083

(57) ABSTRACT

A locator (100) for locating an end of a cable rod comprises a first output device (102) configured to provide a first type of sensory output to a user. A second output device (104) is configured to provide a second type of sensory output to the user. The second type of sensory output is different to the first type of sensory output, and the locator is connectable to the end of the cable rod. A system for locating an end of a cable rod is also provided, the system comprising the locator and a controller (550) configured to send a wireless signal to the locator.

The invention relates generally to a locator for locating an end of a cable rod. More particularly, but not exclusively, the invention relates to a locator for assisting an electrician in locating an end of a cable rod during installation of electrical and signal cable wiring.

### BACKGROUND

Cable rods are used by electricians to route and retrieve electrical cable wiring through walls, under floorboards, ceiling ducts and many other difficult to reach areas that may be encountered during an installation of electrical wiring. These cable rods are particularly useful in situations where an electrician needs to route or retrieve cable wiring over long distances within inaccessible voids of a building. Depending on the needs of an electrician, different cable rod tips can be attached to an end of a cable rod to assist in carrying out an operation. For example, a cable rod tip having a hook may be attached to a cable rod to assist an electrician in retrieving loose electrical cable wiring that is out of reach. Alternatively, a cable rod tip having a ring end could be used to assist the electrician in routing electrical cable wiring through a cavity wall for fitting, for example, wall outlets, light fixtures and switches.

When routing or retrieving electrical cable wiring over long distances through inaccessible areas in a building, an electrician may not know where the end of a cable rod is located while pulling or feeding the cable rod through the building. Current tactics for locating an end of a cable rod include the provision of a cable rod tip having an LED light to provide illumination of a dark space in which the cable rod tip is fed. However, illumination of a space only assists an electrician in locating the end of a cable rod when the electrician has at least partial visual access to the space. These cable rod tips are therefore not suitable for many instances of electrical installations where an electrician is unable to maintain visual contact with the end of a cable rod during an operation. The LED light provided by these cable rod tips being white also means that the light emitted by the cable rod tip is not distinguishable from other light sources that are commonly encountered during electrical installations, which reduces the effectiveness of the cable rod tip to locate the end of a cable rod.

A cable rod having a transmitter at an end of the cable rod for emitting radio waves and a separate handheld radio receiver unit have also been used for locating the end of a cable rod. An electrician feeds the cable rod through a cavity in a wall and uses the handheld receiver unit to locate the end of the cable rod by moving the receiver unit along the wall to find the position where the radio signal is at a maximum. However, the use of radio waves for locating the end of cable rods may not be suitable for use in building structures (for example, buildings in which the walls are made from thick stone) that heavily attenuate radio waves. In such cases, the radio waves transmitted from the end of the cable rod may reflect from internal surfaces within a building structure and repeatedly bounce around without being sufficiently detected by the receiver unit to enable accurate identification and location of the end of a cable rod.

Further, having a separate handheld receiver that needs to be moved closer to the end of the cable rod means that, in situations where the cable rod is fed a large distance through a cavity wall, an electrician is unable to operate the cable rod and the receiver at the same time.

The present invention has been devised with the foregoing in mind.

### SUMMARY OF INVENTION

According to a first aspect of the invention, there is provided a locator for locating an end of a cable rod. The locator may comprise a first output device configured to provide a first type of sensory output to a user. The locator may comprise a second output device configured to provide a second type of sensory output to the user. The second type of sensory output may be different to the first type of sensory output. The locator may be connectable to the end of the cable rod.

Having more than one type of sensory output enables a user to locate the end of the cable rod even if the environment blocks or weakens a particular type of sensory output. For example, if the locator is used in a visually obstructed environment, having a second type of sensory output which is not a visual output ensures the user is still able to locate the end of the cable rod.

The locator may comprise a third output device. The third output device may be configured to provide a third type of sensory output to the user. The third type of sensory output may be different to the first type of sensory output and/or the second type of sensory output.

Having a third type of sensory output ensures that a user can still locate the end of the cable rod even in an environment where two types of sensory output are blocked or non-useful.

The locator may comprise a receiver. The locator may comprise a first switch. The switch may be activated by the receiver in response to the receiver receiving a signal. The signal may be from a controller. The signal may be a wireless signal. The first switch may be integral with the receiver.

Having a switch which is activated remotely via a wireless signal ensures that the output devices are only activated when required by the user. This reduces total power consumption.

The locator may be, or comprise, an antenna which is configured to receive a wireless signal from the controller and generate an electrical signal. The electrical signal generated by the antenna may operate the first switch for controlling supply of power to the output devices.

The receiver may be a transceiver. The transceiver may enable two-way communication between the locator and the controller. The transceiver may be a Bluetooth transceiver.

The locator may comprise a camera. The camera may be configured to capture images. The camera may be configured to capture video footage. The transceiver may be configured to transfer the images and/or video footage to the controller.

One or more of the output devices of the locator may be configured to provide an audio output. The output device(s) configured to provide audio output may include a buzzer (or buzzers). The output device(s) configured to provide an audio output may include a speaker (or speakers). If more than one output device is configured to provide audio feedback, the audio output provided by each output device may have different frequencies.

One or more of the output devices of the locator may be configured to provide visual output. The output device(s) configured to provide visual output may include a light source (or light sources). The light source (or light sources) may be non-white and non-yellow light source(s).

Non-yellow and non-white light sources may be more easily observed by a user of the locator because they may provide a better contrast against background materials and may differentiate over alternative nearby light sources.

The light source (or light sources) may be LED light source(s). The light sources may be a laser (or lasers). If more than one light source is used, then the light sources may produce light with different spectra.

One or more of the output devices of the locator may be configured to provide vibrational feedback. The output device(s) configured to provide vibrational feedback may include a vibrator. If more than one vibrator is used, then the vibrators may produce different vibration outputs.

The locator may comprise an attachment mechanism for attaching the locator to the end of the cable rod. The attachment mechanism may be integral with the locator. The attachment mechanism may be attachable to the end of a cable rod. The attachment mechanism may comprise a thread configured to receive a corresponding threaded cable rod. The attachment mechanism may be magnetic. The attachment mechanism may comprise a cylindrical recess configured to receive the end of the cable rod.

Having a secure attachment mechanism ensures the locator stays on the end of the cable rod, thus enabling a user to reliably use the locator to locate the cable rod end.

The locator may comprise a second switch for controlling supply of power to the output devices. The second switch may be configured to be activated when the locator is connected to the end of the cable rod via the attachment mechanism. The second switch may be a spring-loaded switch which is activated when the spring of the spring-loaded switch is compressed by the end of a cable rod. The second switch may be a switch that is activated by a user of the locator prior to use.

The first and second switches may be arranged in series such that both switches must be activated in order to enable the supply of power to the output devices.

The second switch may control the supply of power to the receiver. The second switch may enable the operation of the first switch.

The locator may comprise a rechargeable battery configured to supply power to the output devices. The locator may comprise a charging port configured to enable connection between the rechargeable battery and an external power source. The charging port may be integral with the attachment mechanism.

The locator may comprise a power source which is moveable between a first position wherein the power source is electrically disconnected from the output devices, and a second position wherein the power source is electrically connected to the output devices.

The power source may be moveable from the first position to the second position in response to connection of the cable rod to the locator.

The power source may be disposed between a first spring which provides an electrical connection between the power source and the output devices and a second spring which provides an electrical connection between the power source and the charging port.

The charging port may comprise a magnetic female charging port. The female charging port may be configured to move along a longitudinal axis of the locator within the attachment mechanism. The female charging port may be configured to connect to a male magnetic charging portion.

The power source may comprise a first end comprising a central positive terminal surrounded by a negative terminal. The power source may comprise a second end comprising a central negative terminal surrounded by a positive terminal.

According to a second aspect of the invention, there is provided a charging case for holding a locator for locating an end of a cable rod. The charging case may comprise a first attachment slot for attaching to a locator. The charging case may comprise a second attachment slot for attaching to a second electrician tool. The second electrician tool may be a detachable voltage detector. The first attachment slot and the second attachment slot may be located on opposite ends of the charging case.

The charging case may comprise a first charging port which is configured to connect to and charge the locator. The first charging port may be located within the first attachment slot. The charging case may comprise a second charging port which is configured to connect to and charge the second electrician tool. The second charging port may be located within the second attachment slot.

The first attachment slot and/or the second attachment slot may be magnetic attachment slots. The first charging port and/or the second charging port may be magnetic charging ports.

The charging case may comprise a self-charging port which is configured to connect to a power supply.

The charging case may comprise a rechargeable battery. The rechargeable battery within the charging case may be recharged by connecting the charging case to an external power supply via the self-charging port. The power stored within the rechargeable battery may be used to recharge a rechargeable battery within a locator and/or a rechargeable battery within a detachable voltage detector when the locator and/or the detachable voltage detector are attached to the charging case via the attachment slots.

The charging case may comprise an inspection light.

The charging case may comprise a pocket clip which is configured to secure the charging case to, for example, a pocket in clothing worn by a user.

The charging case may comprise an activation button which is configured to control operation of the output device(s) on a locator according to the first aspect. In this way, the charging case may be the controller which is configured to send a wireless signal to the receiver. The activation button on the charging case may be located on the body of the charging case and located directly below the pocket clip such that a user can activate the activation button by pressing the pocket clip down on the body of the charging case.

The charging case may comprise more than one activation button for controlling operation of each output device.

According to a third aspect of the invention, there is provided a system comprising a locator for locating an end of a cable rod and a controller configured to send a wireless signal to the locator.

The locator may be a locator according to the first aspect of the invention. The controller may be the charging case of the second aspect.

The controller may further comprise activation button(s) that is/are configured to control operation of the output device(s) on the locator. The controller may have one activation button for controlling operation of each output device. The controller may have a single activation button for controlling operation of all the output devices of the locator.

The controller may send the wireless signal via a transmitter. The transmitter may be an antenna. The transmitter may be a transceiver. The transmitter may be configured to provide two-way communication between the locator and controller.

The controller may comprise a display. The display may be configured to display data received by the controller's transceiver and sent from the locator's transceiver.

The controller may comprise a charging port. The charging port may be a magnetic charging port. The charging port may be configured to connect to and charge the locator.

The controller may comprise a detachable voltage detector.

In some embodiments, the system may further comprise a charging case according to the second aspect of the invention. In these embodiments, the controller is used as a controller for controlling operation of the output devices and the charging case is used for charging a locator and/or a detachable voltage detector.

According to a fourth aspect of the invention, there is provided an electronic device.

The electronic device may be a locator. The electronic device may comprise any of the features described in relation to the locator of the first aspect.

The electronic device comprises one or more output devices.

The electronic device comprises a power source moveable between a first position and a second position. In the first position, the power source may be electrically disconnected from the one or more output devices. In the second position, the power source may be electrically connected to one or more output devices.

The power source may comprise a positive terminal connected via a first spring to a female charging port. The first spring may be electrically conductive. The female charging port may comprise a conductive portion. The conductive portion of the female charging port may be electrically connected to the positive terminal of the power source via the first spring. The female charging port may be magnetic. The female charging port may be configured to connect to a male charging member. The female charging port may be configured to provide electrical contact between a positive terminal of the power source and a male charging member to enable charging and recharging of the power source.

The power source may comprise a negative terminal connected via a second spring to the one or more output devices. The second spring may be electrically conductive and provide an electrical connection between the negative terminal of the power source and a negative terminal of the one or more output devices.

The electronic device may be configured such that, in the second position, the positive terminal of the power source forms an electrical contact with a positive terminal of the output devices.

The electronic device may be configured such that, upon insertion of an external component (such as a cable rod), the female charging port is pushed towards the power source. Pushing the female charging port towards the power source may cause to move into electrical contact with the output devices.

Optional features of any of the above aspects may be combined with the features of any other aspect, in any combination. For example, features described in connection with the locator of the first aspect may have corresponding features definable with respect to the system of the third aspect, and vice versa, and these embodiments are specifically envisaged. Features which are described in the context or separate aspects and embodiments of the invention may be used together and/or be interchangeable wherever possible. Similarly, where features are, for brevity, described in the context of a single embodiment, those features may also be provided separately or in any suitable sub-combination.

### BRIEF DESCRIPTION OF THE DRAWINGS

The invention will now be described, by way of example only, with reference to the accompanying drawings, in which:

FIG. 1 shows a schematic of a locator for locating an end of a cable rod according to an embodiment of the invention;

FIG. 2 shows a schematic of another locator for locating an end of a cable rod according to an embodiment of the invention;

FIG. 3 shows a schematic of another locator for locating an end of a cable rod according to an embodiment of the invention;

FIG. 4 shows a schematic circuit diagram for a locator for locating an end of a cable rod in accordance with present invention;

FIG. 5 shows a perspective view of the locator of FIG. 4;

FIGS. 6 (a)-(d) respectively show front, left, right and back views of the locator of FIG. 5;

FIGS. 7 (a) and (b) respectively show top and bottom views of the locator of FIG. 6;

FIG. 8 shows a perspective view of a controller for controlling a locator for locating an end of a cable rod;

FIG. 9 shows a partially transparent perspective view of the controller of FIG. 8;

FIG. 10 shows a schematic view of a system comprising a controller and a locator for locating an end of a cable rod according to the present invention;

FIG. 11 shows a perspective view of a charging case for use with a locator for locating an end of a cable rod;

FIG. 12 shows a perspective view of the charging case of FIG. 11 attached to a locator and a detachable voltage detector;

FIG. 13 (a)-(d) respectively show front, left, right and back views of the charging case of FIG. 11 attached to a locator and a detachable voltage detector;

FIGS. 14 (a) and (b) respectively show top and bottom views of the charging case of FIG. 11;

FIG. 15 shows an example use a locator with a cable rod during an electrical installation;

FIG. 16 shows another example use of a locator with a cable rod during an electrical installation; and

FIG. 17 shows another example use of a locator with a cable rod during an electrical installation;

FIGS. 18 (a) and (b) show front views of a locator with a power source in first and second positions respectively;

FIGS. 19 (a) and (b) show top and bottom perspective views of a power source for use in the locator of FIGS. 18 (a) and (b);

FIG. 20 shows a simplified cross-sectional view of the locator of FIG. 18, taken along the length of the locator, with the power source in the second position; and

FIG. 21 shows a simplified cross-sectional view of the locator of FIG. 18, taken along the length of the locator, with the power source in the second position.

### DETAILED DESCRIPTION

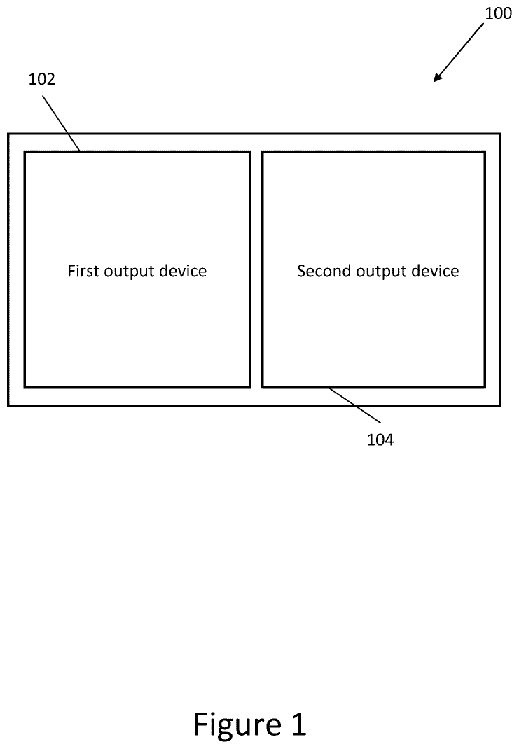

FIG. 1 shows a schematic of a locator 100 for locating an end of a cable rod. The locator 100 is connectable to the end of a cable rod and is configured to alert a user to its location.

The locator comprises a first output device 102 that is configured to provide a first type of sensory output to a user. The locator comprises a second output device 104 that is configured to provide a second type of sensory output to the user. The first type of sensory output is different to the second type of sensory output.

The “type of sensory output” refers to a type of sensory stimulation provided by that output. Examples of types of sensory output include, but are not limited to: visual outputs, audio outputs, tactile outputs, vibrational outputs, etc.

Example output devices which are configured to provide visual outputs include, but are not limited to, LEDs, bulbs, and lamps. Example output devices which are configured to provide audio outputs include, but are not limited to, buzzers, speakers, and vibrators.

In some embodiments, the first output device 102 and the second output device 104 are configured to provide at least two of: audio output, visual output and vibrational output. For example, in some embodiments, the first output device 102 is configured to provide audio output and the second output device 104 is configured to provide visual output. In an alternative embodiment, the first output device 102 is configured to provide visual output and the second output device 104 is configured to provide vibrational feedback.

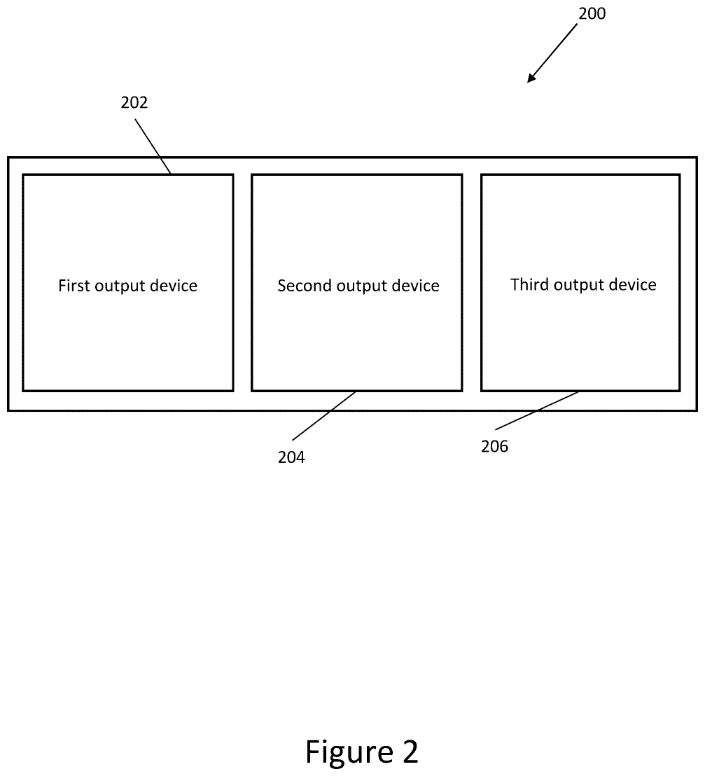

FIG. 2 shows a schematic of a locator 200 for locating an end of a cable rod according to another embodiment. The locator 200 comprises a first output device 202, a second output device 204 and a third output device 206. The first output device 202, the second output device 204 and the third output device 206 are configured to respectively provide a first, a second and a third type of sensory output, wherein each type of sensory output is different from the other two types of sensory output.

In some embodiments, the first output device 202 is configured to provide audio output, the second output device 204 is configured to provide visual output, and the third output device 206 is configured to provide vibrational output.

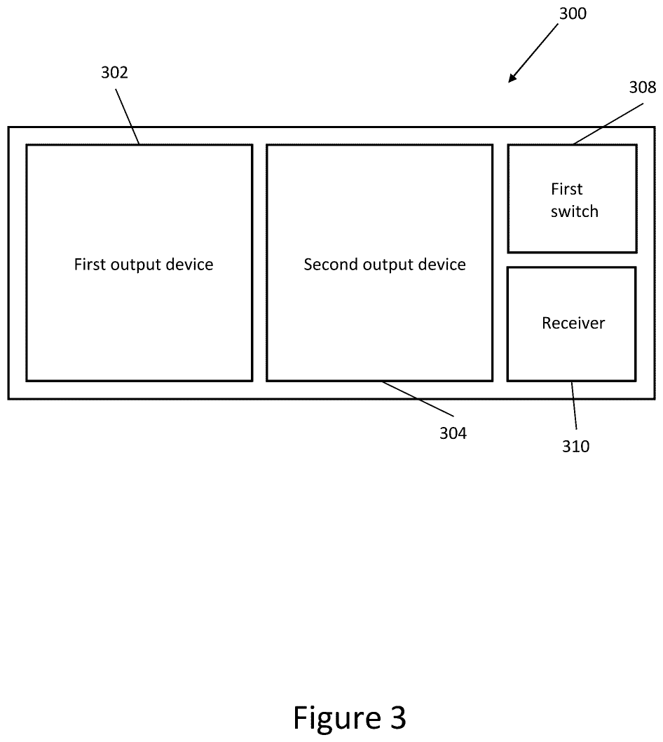

FIG. 3 shows a schematic of a locator 300 for locating an end of a cable rod according to another embodiment. Similar to the locator 100 of FIG. 1, the locator 300 comprises a first output device 302 and a second output device 304. The locator 300 comprises a receiver 310 configured to detect wireless signals (e.g., electromagnetic waves). The locator 300 comprises a first switch 308 configured to control the supply of power from a power source (not shown in FIG. 3) to the output devices 302, 304.

The receiver 310 controls the first switch 308. In some embodiments, the receiver 310 detects a wireless signal (for example, from a controller) and, in response, turns the first switch 308 on to activate the output devices 302, 304. In some embodiments, the first switch 308 is integral with the receiver 310 (i.e., they are a single component). In other embodiments, the first switch 308 is separate from the receiver 310 and receives a signal from the receiver.

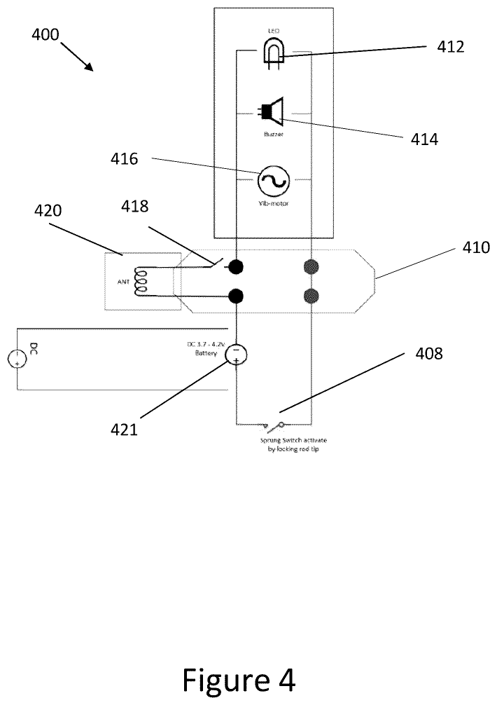

FIG. 4 shows a circuit diagram for a locator 400 according to another embodiment. The locator 400 comprises a receiver 410 which comprises an antenna 420 and a first switch 418. The antenna 420 of the receiver 410 detects wireless signals to control the first switch 418.

The locator 400 comprises three different output devices 412, 414, 416, a power source 421, and a second switch 408 for controlling supply of power to the three output devices. The power source 421 is connected to output devices 412, 414, 416. The power source 421 is arranged in series with the first and second switches such that both the first switch 418 and the second switch 408 must be closed (i.e., turned on) in order to enable current to flow from the power source 421 to the output devices 412, 414, 416. In this embodiment, the power source 421 is a DC battery. In other embodiments, alternative power sources can be used.

As shown in FIG. 4, the first output device 412 is an LED light source, the second output device 414 is a buzzer, and the third output device 416 is a vibrator. In this embodiment, the output devices 412, 414, 416 are arranged in parallel. In other embodiments, the output devices 412, 414, 416 can be arranged in series.

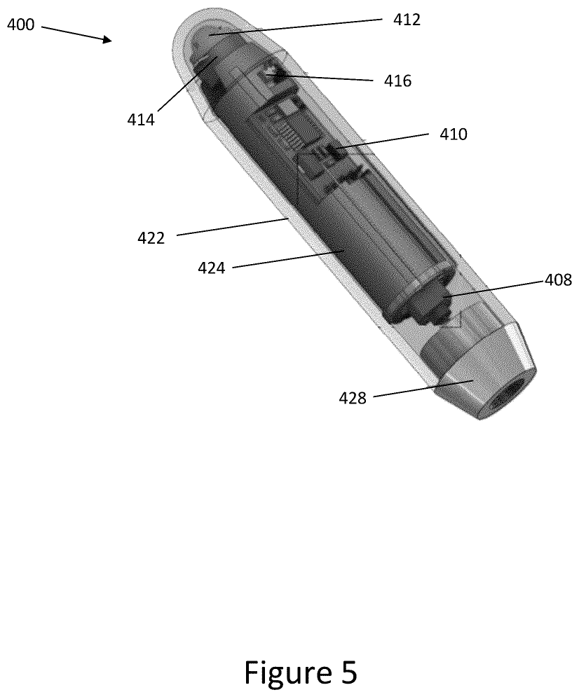

FIG. 5 shows a perspective view of the locator 400. The locator 400 comprises a housing 422. The locator 400 further comprises a component holder 424, which is located within the housing 422. The component holder 424 holds (i.e., fixes the relative positions) the LED light source 412, the buzzer 414, the vibrator 416, the wireless receiver 410 and the battery (not shown in FIG. 5).

The locator 400 comprises an attachment mechanism 428 configured to enable attachment of the locator 400 to the end of a cable rod. The second switch 408 is aligned with the attachment mechanism 428. The second switch 408 is a spring-loaded switch. The switch 408 is positioned such that it is compressed (i.e., turned on) when the locator 400 is connected to an end of a cable rod and the end of the cable rod is received within the attachment mechanism 428. The second switch 408 is configured to be compressed (i.e., turned on) by the end of the cable rod. Therefore, the second switch 408 is configured to enable power to be supplied to the output devices 412, 414, 416 when the locator 400 is attached to an end of a cable rod.

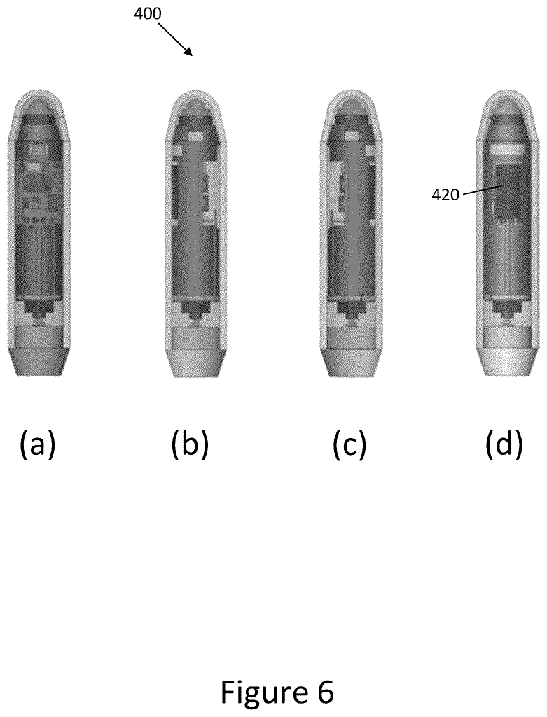

FIGS. 6 (a)-(d) respectively show a front, left, right and back views of the locator 400 of FIG. 5.

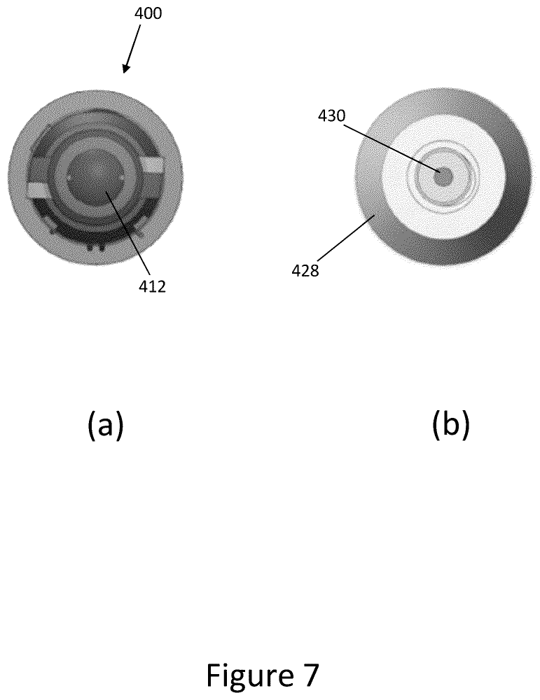

FIGS. 7 (a) and (b) respectively show top and bottom views of the locator 400. As shown in FIGS. 7 (a), the LED light source 412 is located at the top of the locator 400. As shown in FIG. 7 (b), the attachment mechanism 428 is located at the bottom of the locator 400. The locator 400 further comprises a charging point 430 within the attachment mechanism 428. The charging point 430 enables the connection of the battery 421 to an external power supply in order to recharge the battery 421.

In this embodiment, the charging point 430 is a magnetic pogo pin connector. In other embodiments, the charging point 430 can be, or comprise, any other type of electrical connector. For example, in some embodiments, a 2.5 mm or 3.5 mm jack, or a DC power jack, could be used to provide the charging point 430.

In some embodiments, the attachment mechanism 428 is a magnetic attachment mechanism with a magnet that attracts a magnet on an end of a cable rod. In other embodiments, the attachment mechanism 428 is a threaded attachment mechanism which comprises a thread which corresponds to a thread on an end of a cable rod. In other embodiments, the attachment mechanism 428 can be any suitable mechanism for securing a connection between the locator 400 and the end of the cable rod.

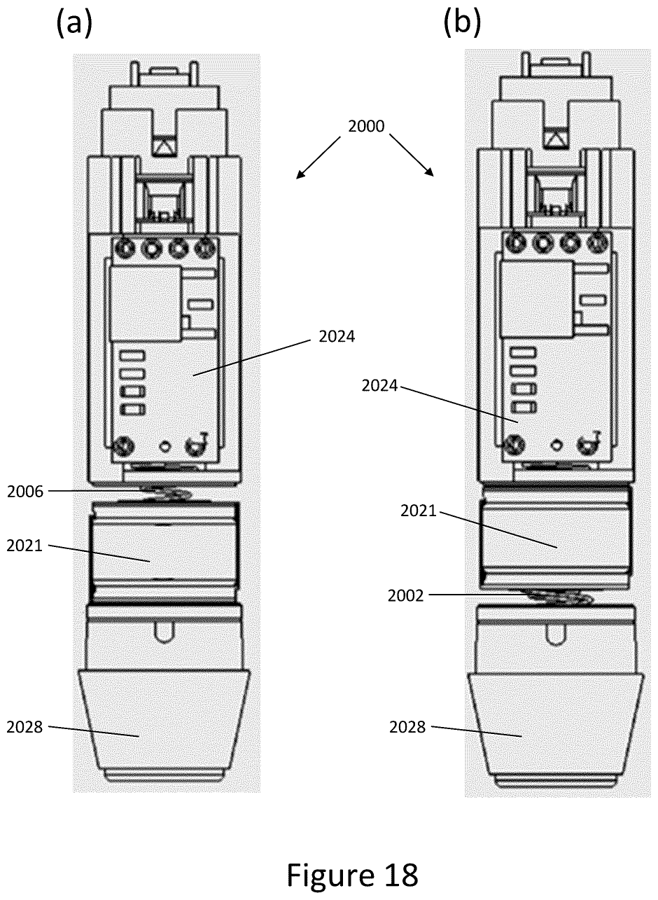

FIGS. 18 (a) and (b) show front views of a locator 2000. The locator 2000 can comprise any of the features described in relation to any of the other locators described herein.

The locator 2000 comprises a power source 2021 which is adjustable between a first position and a second position, shown in FIGS. 18 (a) and (b) respectively.

In the first position, the power source 201 abuts an attachment mechanism 2028. The attachment mechanism 2028 can comprise internal threads configured to engage with external threads of a cable rod. The attachment mechanism can be any of the attachment mechanisms described herein.

In the second position, the power source 201 abuts the component holder 2024 and forms electrical contact with output devices (e.g., lights, buzzers, speakers, etc) of the locator.

The power source 2021 is disposed between two springs. A first spring 2002 is disposed between the power source 2021 and the attachment mechanism 2028. A second spring 2006 is disposed between the power source 2021 and the component holder 2024.

When the locator 2000 is not connected to any external components (such as the cable rod), the force exerted on the power source 2021 by the second spring 2006 is greater than the force exerted on the power source 2021 by the first spring 2002 such that the power source 2021 is in the first position.

In use, a cable rod can be connected to the locator 2000 via the attachment mechanism 2028. Connecting a cable rod to the locator 2000 compresses the first spring 2002, thereby increasing the force exerted on the power source 2021 and causing it to move from the first position to the second position.

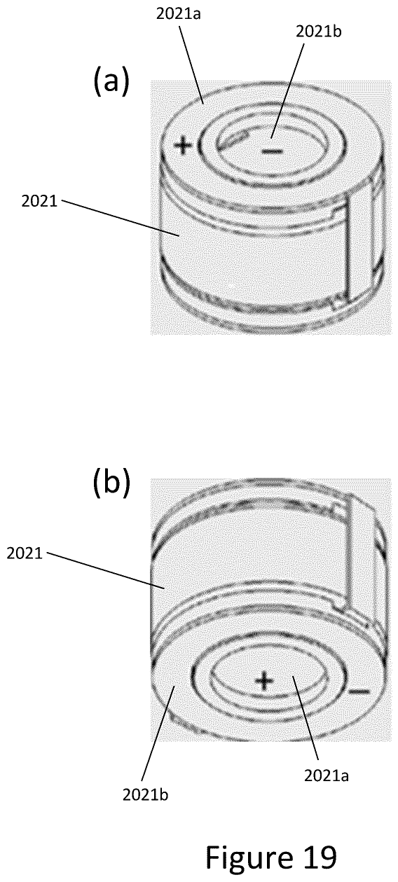

The power source 2021 is shown in greater detail in FIGS. 19 (a) and 19 (b). FIG. 19 (a) shows a top perspective view of the power source 2021. FIG. 19 (b) shows a bottom perspective view of the power source 2021. The terms “top” and “bottom” with reference to the power source 2021 refer to the sides of the power source which contact the component holder 2024 and the attachment mechanism 2028 respectively.

The power source 2021 is a rechargeable power source comprising a positive terminal 2021a and a negative terminal 2021b. The power source 2021 can be any type of rechargeable battery. Although a substantially cylindrical power source 2021 is shown in the Figures, the skilled person will recognise that the shape is not limiting, and alternative (e.g., cuboidal, irregular) shapes can be used.

At the top side of the battery 2021 (shown in FIG. 19 (a)), the positive terminal 2021a forms a ring extending around the peripheral edge of the power source 2021. The negative terminal 2021b is formed as a central portion, inside the ring of the positive terminal 2021a.

At the bottom side of the power source 2021 (shown in FIG. 19 (b)), the terminal positions are swapped relative to the top side. The negative terminal 2021b forms a ring extending around the peripheral edge of the power source 2021. The positive terminal 2021a is formed as a central portion, inside the ring of the negative terminal 2021b.

The positive terminal 2021a of the top and bottom sides of the power source 2021 are connected via an arm extending along the outer edge of the power source 2021. The negative terminal 2021b of the top and bottom sides of the power source 2021 are connected via an arm extending along the outer edge of the power source 2021.

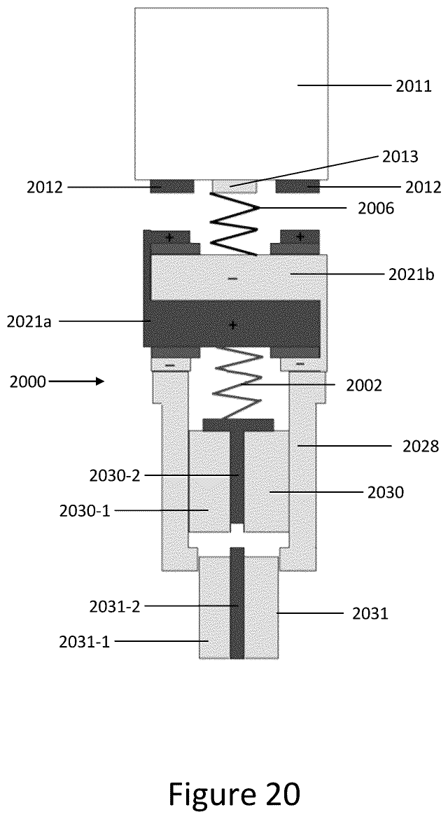

FIG. 20 shows a simplified cross-sectional view of the locator 2000 taken along the length of the locator 2000. In FIG. 20 the locator 2000 is between the first and second positions of FIGS. 19 (a) and 19 (b).

In FIG. 20, the component holder and individual components are omitted for clarity. Instead, the outputs are represented via a box 2011.

Although FIG. 20 shows a locator, the mechanism can be applied to any electrical system or device to provide a dual-purpose charging system. The mechanism of FIG. 20 provides charging as well as a switching function for outputs 2011. The outputs 2011 can be any electronic output device required by the user.

The locator 2000 comprises a female magnetic charging port 2030. The female magnetic charging port 2030 is slidably retained within the attachment mechanism 2028. The female magnetic charging port 2030 is configured to move along the longitudinal axis of the locator 2000 within the attachment mechanism 2028. The female charging port 2030 comprises a magnetic body 2030-1 and a conductive central portion 2030-2.

The first spring 2002 is electrically conductive and creates a permanent electrical contact between the positive terminal 2021a of the power source 2021 and the conductive central portion 2030-2 of the female magnetic charging port 2030.

When a user wants to recharge the power source 2021, a male magnetic charging member 2031 is inserted into the attachment mechanism 2028. The male magnetic charging member 2031 comprises a magnetic body 2031-1 and a conductive central portion 2031-2.

As the male magnetic charging member 2031 is brought into proximity with the female magnetic charging port 2030, the respective magnetic bodies 2030-1, 2030-2 exert an attractive magnetic force upon each other, causing them to move into contact. When the magnetic bodies 2030-1,2 are in contact, the conductive central portion 2031-2 of the male magnetic charging member 2031 forms an electrical contact with the conductive central portion 2030-2 of the female magnetic charging port 2030, thereby forming an electrical connection between the conductive central portion 2031-2 of the male magnetic charging member 2031 and the positive terminal 2021a of the power source 2021. This enables the user to charge and recharge the power source 2021.

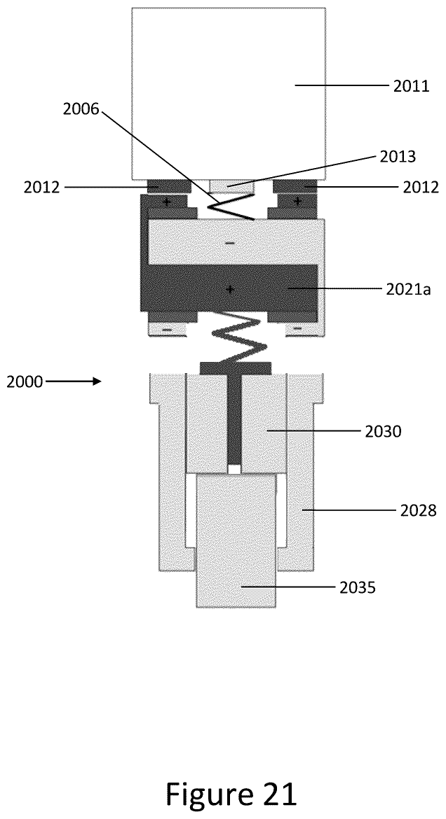

FIG. 21 shows a simplified cross-sectional view of the locator 2000 taken along the length of the locator 2000. In FIG. 21, the locator 2000 is in the second position, as in FIG. 19 (b).

In use, when a user connects a cable rod 2035 to the attachment mechanism 2028, the female magnetic charging port 2030 is pushed towards the power source 2021. As a result of the movement of the female magnetic charging port 2030, the force exerted on the power source 2021 via the first spring 2002 increases and causes the power source 2021 to move away from the attachment means 2028 towards the outputs 2011. The power source 2021 moves from the first position (FIG. 19 (a)) to the second position (FIGS. 19 (b) and 21).

In the second position, as shown in FIG. 21, the positive terminal 2021a of the power source 2021 contacts a positive terminal 2012 of the outputs 2011. A negative terminal 2013 of the outputs 2011 is connected to the negative terminal 2021b of the power source 2021 via the electrically conductive second spring 2006. The electrical connections in FIG. 21 enable the power source 2021 to supply power to outputs 2011.

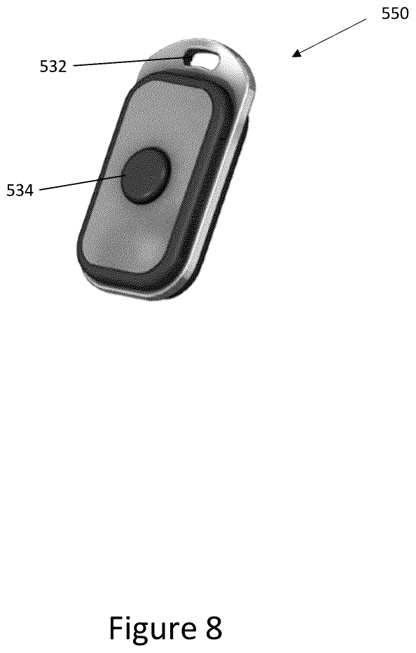

FIG. 8 shows a controller 550 for controlling a locator. For example, the controller 550 can be configured to control any of the locators described above in relation to FIGS. 1-7.

The controller 550 comprises a key-ring slot 532. The controller 550 comprises an activation button 534 which is used for wireless activation of the output devices of a locator. In response to a user pressing the activation button 534, the controller 550 sends a wireless signal which is detected by a receiver of a locator. In turn, the detection of the wireless signal by the receiver activates the output devices of the locator.

The wireless signal sent between the controller 550 and locator can be any standard wireless transmission method. For example, infrared, Bluetooth, or any other wireless signal can be used.

In some embodiments, the controller 550 is configured to start sending out a wireless signal to a locator when a user presses the activation button 534 and stop sending out the wireless signal when a user presses the activation button 534 for a second time. In such an embodiment, the output device(s) on the locator are only activated while the locator is receiving a wireless signal from the controller 750.

In other embodiments, the controller transmits the wireless signal for a predefined of time after a user presses the activation button 534.

In some embodiments, the controller 550 has a separate activation button for controlling operation of each of the output devices on a locator. For example, the controller may have a first activation button for controlling the operation of an LED light source, a second activation button for controlling operation of a buzzer and a third activation button for controlling operation of a vibrator.

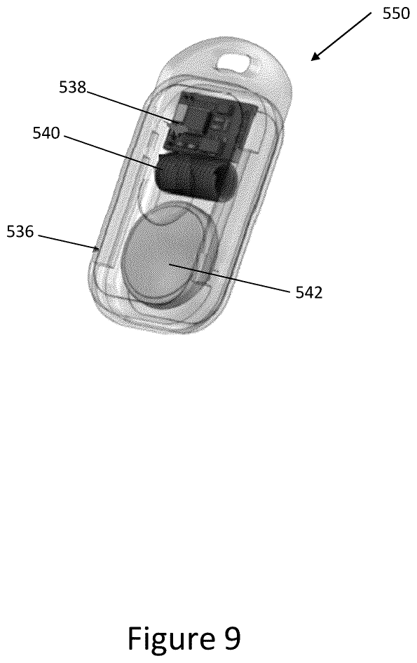

FIG. 9 shows a partially transparent perspective view of the controller 550 of FIG. 8. The controller 550 comprises an outer casing 536 which houses a transmitter 538, an antenna 540 and a power source 542. In this embodiment, the power source 542 is a battery. The battery 542 is configured to supply power the transmitter 538 to enable the transmitter 538 produce an electrical signal in response to the user pressing the activation button 534. The electrical signal produced by the transmitter flows through the antenna 540 to generate the wireless signal which is configured to control operation of a locator.

Although the antenna 540 is shown as a coil-type antenna in FIG. 9, in other embodiments the antenna 540 may be any other type of antenna, such as a dipole-type antenna. The antenna 540 may be a directional antenna or an omni-directional antenna.

In some embodiments, the wireless signal is a radio frequency electromagnetic wave. The radio wave can be a modulated wave which is configured to encode instructions for controlling operation of the output device(s).

In some embodiments, any suitable controller for activating a switch within a locator can be used. For example, in some embodiments, the controller may be a user device such as a smartphone, tablet, or PC.

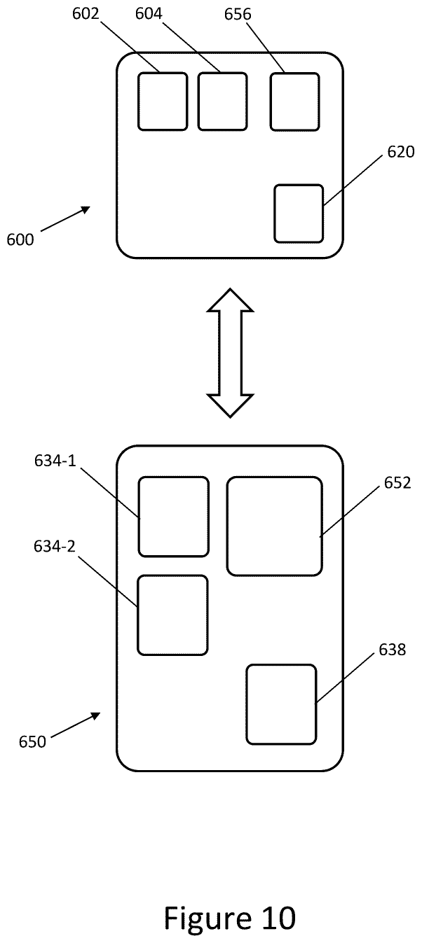

In some embodiments, the controller is in two-way communication with the locator, as described below in relation to FIG. 10.

FIG. 10 shows a system comprising a locator 600 and a controller 650. In some embodiments, the controller 650 is a specialist device but, in other embodiments, the controller 650 is a user device, such as a smart phone.

The locator comprises a first transmitter 620. The first transmitter 620 is configured to communicate with a second transmitter 638 which is part of the controller 650. The first and second transmitters 620, 638 are in two-way communication, meaning data signals can be sent in either direction between the transmitters 620, 638.

In some embodiments, the transmitters 620, 638 are Bluetooth 5.0+ transmitters. In other embodiments, any other suitable technology for enabling wireless two-way communication can be used.

The locator comprises a first output device 602 and a second output device 604. As described in relation to earlier embodiments, the first output device 602 is configured to provide a different type of sensory output to the second output device 604.

The controller 650 comprises a first activation button 634-1 and a second activation button 634-2. The first and second activation buttons 634-1, 2 are configured to control operation of the first and second output devices 602, 604 respectively. When a user presses an activation button 634-1, 2, a signal is sent via the transmitters 620, 638 to activate the corresponding output device 602, 604.

In other embodiments, a single activation button is used to control both output devices. In other embodiments, there are more than two output devices, and the output devices are controlled via one or more activation buttons.

The locator comprises a camera 656. In some embodiments, the camera 656 is configured to capture images. In some embodiments, the camera 656 is a video camera configured to capture video recordings. The data (e.g., video footage or images) captured by the camera 656 is sent from the locator 600 to the controller 650 via the transmitters 620, 638 and is shown on a display 652 of the controller 650. In some embodiments, the camera 656 is activated via an additional activation button on the controller.

In some embodiments, the camera 656 and the display are not present. In some embodiments, the locator 600 comprises an alternative device for obtaining data (e.g., a type of sensor or microphone) instead of, or in addition to, a camera. In such embodiments, the display 652 is replaced by a suitable component for conveying the data to the user.

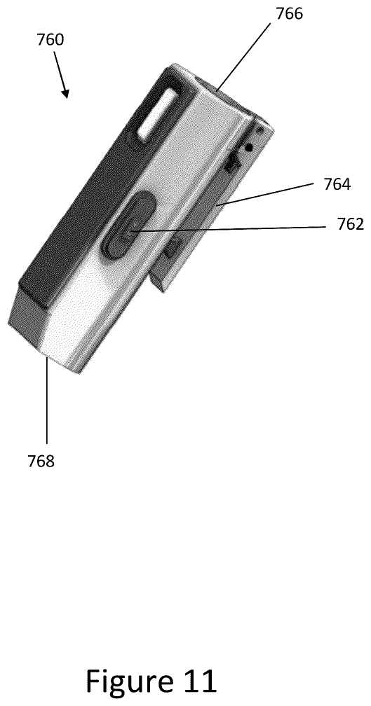

FIG. 11 shows a charging case 760 for use with a locator. The charging case 760 can be configured for use with any of the locators described in any of FIGS. 1-7. The charging case 760 enables a user to carry and charge the locator. The charging case 760 is designed to enable an electrician to carry multiple tools, including the locator, simultaneously.

The charging case 760 comprises a pocket clip 764 for securing the charging case 760 to a pocket of a user.

The charging case 760 comprises a charging port 762 configured to enable connection to an external power supply. In the embodiment of FIG. 11, the charging port 762 comprises a magnetic pogo pin connector but in other embodiments, any other suitable charging port can be used.

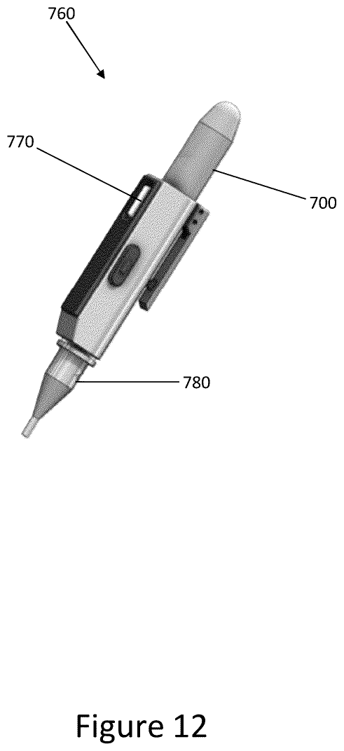

The charging case 760 comprises a first magnetic attachment slot 766 for securing a locator to the charging case 760. The charging case 760 comprises a second magnetic attachment slot 768 for securing a second device, such as a detachable voltage detector, to the charging case 760, as shown in FIGS. 12-14. The first magnetic attachment slot 766 and the second magnetic attachment slot 768 each have a charging port (not shown in FIG. 11) configured to connect to corresponding charging ports on the locator and the detachable voltage detector.

FIG. 12 shows a perspective view of the charging case 760 of FIG. 11 attached to a locator 700 at a first end of the charging case 760 and attached to a detachable voltage detector 780 at a second end of the charging case 760. The charging case 760 also comprises an inspection light 770 that is built into the body of the charging case 760.

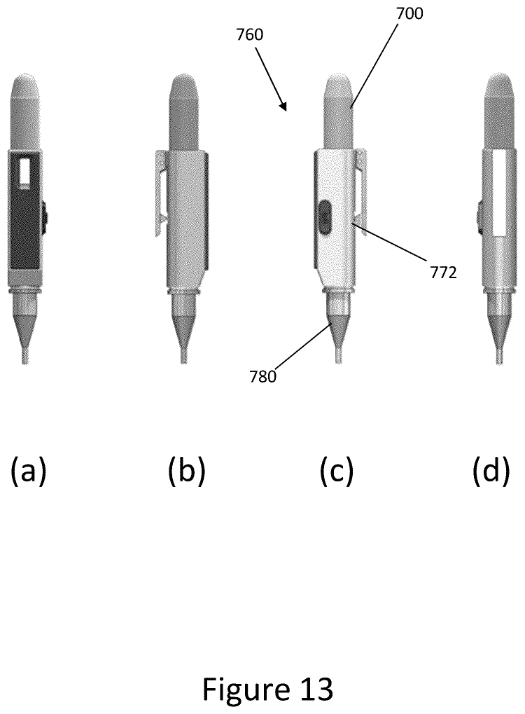

FIGS. 13 (a)-(d) respectively show front, left, right and back views of the charging case 760 when the charging case is attached to the locator 700 and the detachable voltage detector 780.

The charging case 760 comprises an activation switch 772 on the same side of the body of the locator as the pocket clip 764. The activation switch 772 is used to control power supply to the locator 700 and/or the detachable voltage detector 780 when the locator 700 and/or the detachable voltage detector 780 are attached to the charging case 760. The pocket clip 764 comprises a protruding part which is configured to activate the activation switch 772 when the pocket clip is pressed down on the body of the locator 700.

In this embodiment, activating (i.e., pressing) the activation button 772 will supply power for charging a rechargeable battery within the locator 700 and/or the detachable voltage detector 780 when an external power supply is connected to the charging port 762 of the charging case 760. In other embodiments, the charging case 760 includes a rechargeable battery for charging the locator 700 and/or the detachable voltage detector 780. The rechargeable battery is charged via the charging port 762. When using a rechargeable battery, it is not necessary for the charging case 760 to be connected to an external power supply in order to supply power to the locator 700 and the voltage detector 780.

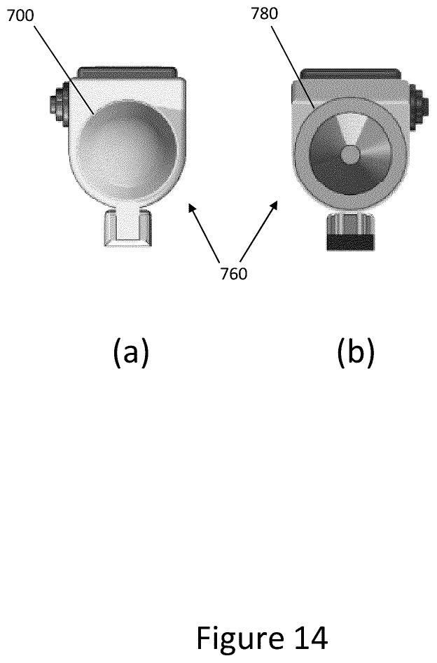

FIGS. 14 (a) and (b) respectively show top and bottom views of the charging case 760 attached to the locator 700 at one end and to the detachable voltage detector 780 at an opposite end.

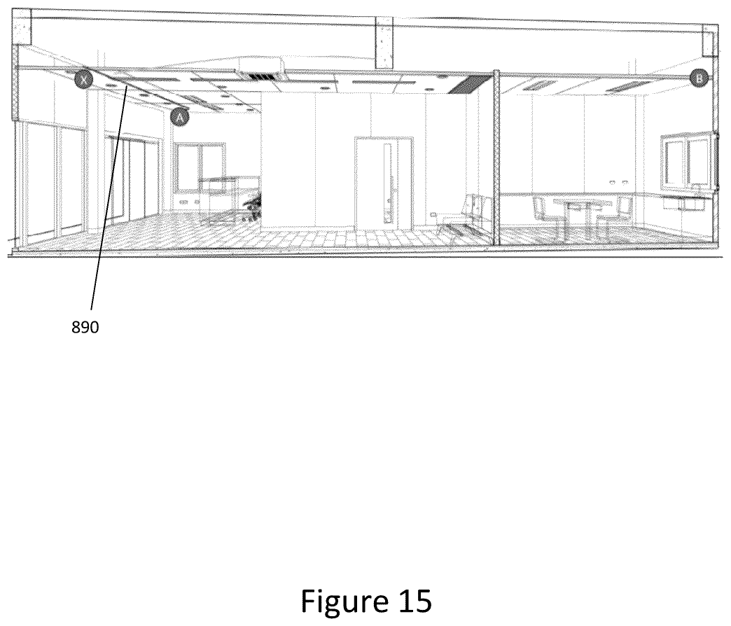

FIG. 15 shows an example use of a locator with a cable rod 890 during an electrical installation within a building. The objective of the electrical installation is to feed a cable above a suspended ceiling of the building from point A to point B. This requires an electrician to feed the cable around an L-shaped bend in the suspended ceiling. The electrician can use a cable rod to assist in feeding the cable from point A to an intermediary point X that is located where the floorplan of the building turns 90 degrees. The electrician must then determine where in the suspended ceiling the end of the cable rod is located so that the cable can be further fed to point B using the cable rod. Since the electrician does not have any visual contact with the end of the cable rod when the cable rod is fed to the intermediary point X, the electrician may take several attempts to locate the end of the cable rod by removing and re-installing ceiling tiles which delays completion of the electrical installation. By using a locator attached to the end of the cable rod having output devices providing audio output and/or vibrational output, the electrician can more quickly locate the end of the cable rod within the suspended ceiling because the electrician is able to hear the audio output and/or feel the vibrational output.

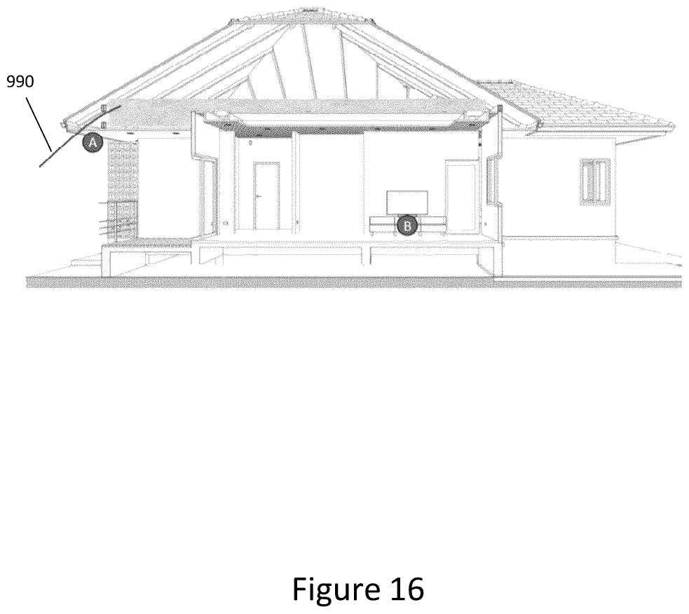

FIG. 16 shows another example use of a locator with a cable rod 990 during an electrical installation. In this electrical installation, an electrician is required to feed the cable rod 990 from a point A which is located outside the building to a point B which is located inside the building. The electrician uses an access point into the loft space of the building by feeding the cable rod through a soffit board in the roof of the building. The electrician must then go into the loft space to locate the end of the cable rod before they are able to continue feeding the cable rod to point B. However, since the loft space is often insulated with thick insulative bedding, the electrician may find it difficult to locate the end of the cable rod. Further, the loft space also contains lots of building structures (for example, joists) and has low ceiling height close to the soffit board which may hinder an electrician in locating the end of the cable rod because their view is obstructed. By using a locator attached to the end of the cable rod having output devices providing visual output, audio output, and/or vibrational output, the electrician can more quickly locate the end of the cable rod within the loft space. Further, by using a locator with a non-white and non-yellow light source, the electrician can more easily locate the end of the cable rod as it differentiates itself from alternative light sources.

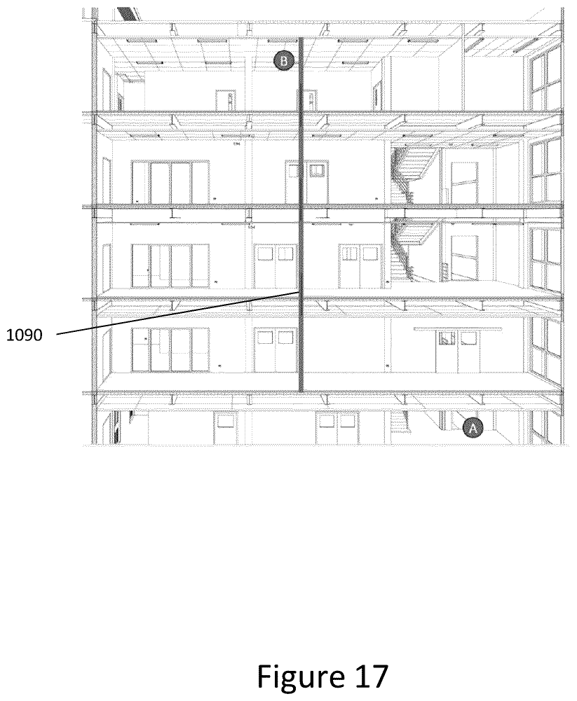

FIG. 17 shows another example use of a locator with a cable rod 1090 during an electrical installation. In this electrical installation, the electrician is required to feed the cable rod 1090 through a building from a point B to a point A which is located several floors below point B. The electrician drills a hole in each of the floors between point A and point B to enable a cable to be installed between these points in the building. When feeding the cable through each of the floors, the electrician first uses a cable rod to feed the cable through a hole in an upper floor and must locate the end of the cable rod to remove a ceiling tile to fetch the end of the cable rod from a lower floor to pull the cable down to the lower floor. However, the electrician may take several attempts to locate where in the ceiling the end of the cable rod is located. By using a locator attached to the end of the cable rod having output devices providing audio output and/or vibrational output, the electrician can more quickly identify a ceiling tile for removal that would give them access to fetch the end of the cable rod.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom.

For the sake of completeness, it is also stated that the term “comprising” does not exclude other elements or steps, the term “a” or “an” does not exclude a plurality, a single processor or other unit may fulfil the functions of several means recited in the claims and any reference signs in the claims shall not be construed as limiting the scope of the claims.

1. A locator for locating an end of a cable rod, comprising:
a first output device configured to provide a first type of sensory output to a user; and
a second output device configured to provide a second type of sensory output to the user, wherein the second type of sensory output is different to the first type of sensory output;
wherein the locator is connectable to the end of the cable rod.

2. The locator of claim 1, further comprising a third output device configured to provide a third type of sensory output to a user, wherein the third type of sensory output is different to both the first and second types of sensory output.

3. The locator of claim 1, further comprising a receiver and a first switch for controlling supply of power to the output devices, wherein the switch is activated by the receiver in response to the receiver receiving a wireless signal from a controller.

4. The locator of claim 1, where one of the output devices is configured to provide audio output.

5. The locator of claim 4, wherein the output device configured to provide audio output is a buzzer.

6. The locator of claim 1, wherein one of the output devices is configured to provide visual output.

7. The locator of claim 6, wherein the output device configured to provide visual output is a light source.

8. The locator of claim 7, wherein the light source is a non-white and non-yellow light source.

9. The locator of claim 1, where one of the output devices is configured to provide vibrational output.

10. The locator of claim 1, further comprising an attachment mechanism attachable to the end of the cable rod.

11. The locator of claim 1, further comprising a power source configured to supply power to the output devices.

12. The locator of claim 11, wherein the locator comprises a charging port configured to enable charging of the power source.

13. The locator of claim 11, wherein the power source is moveable between a first position wherein the power source is electrically disconnected from the output devices, and a second position wherein the power source is electrically connected to the output devices; and
wherein the power source is configured to move from the first position to the second position in response to connection of the cable rod to the locator.

14. The locator of claim 13, wherein the power source is disposed between a first spring which provides an electrical connection between one terminal of the power source and the output devices, and a second spring which provides an electrical connection between one terminal of the power source and the charging port.

15. The locator of claim 14, wherein the charging port comprises a magnetic female charging port, wherein the female charging port is:
configured to move along a longitudinal axis of the locator within the attachment mechanism; and
configured to connect to a male magnetic charging portion.

16. The locator of claim 11, wherein the power source comprises:
a first end comprising a central positive terminal surrounded by a negative terminal; and
a second end comprising a central negative terminal surrounded by a positive terminal.

17. The locator of claim 3, wherein the receiver is a transceiver configured to provide two-way communication with the controller.

18. The locator of claim 17, wherein the locator comprises a camera, and the transceiver is configured to transmit data captured by the camera to the controller.

19. A locator for locating an end of a cable rod, comprising:
a first output device configured to provide a first type of sensory output to a user;
wherein the locator is connectable to the end of the cable rod; and
a power source moveable between a first position wherein the power source is electrically disconnected from the first output device, and a second position wherein the power source is electrically connected to the first output device; and
wherein the power source is moveable from the first position to the second position in response to connection of the cable rod to the locator.

20. A system for locating an end of a cable rod, the system comprising:
the locator of claim 3; and
a controller configured to send a wireless signal to the locator.
